(19) United States
(12) Patent Application Publication
(10) Pub. No.: US 2018/0088591 A1
(43) Pub. Date: Mar. 29, 2018

(54) SYSTEMS, METHODS, AND APPARATUS FOR DYNAMICALLY PLANNING MACHINE DUMPING OPERATIONS

(71) Applicant: Caterpillar Inc., Peoria, IL (US)

(72) Inventor: Paul Friend, Morton, IL (US)

(73) Assignee: Caterpillar Inc., Peoria, IL (US)

(21) Appl. No.: 15/279,006

(22) Filed: Sep. 28, 2016

(51) Int. Cl. G05D 1/02; G01C 21/36

(52) U.S. Cl. CPC G05D 1/0291; G05D 2201/0202; G01C 21/3676

(57) ABSTRACT

A system for planning material dumping operations includes one or more machine controllers and a dump zone controller. Each of the one or more machine controllers are configured to provide dump planning information for the one or more machines and configured to determine actual dump information for dumping operations of machines. The dump zone controller is communicatively coupled with each of the one or more machine controllers and configured to initialize a dump zone. The dump zone controller is configured to plan an array of dump locations at the dump zone, each dumping location associated with a dumping operation. The dump zone controller is further configured to update the array of dump locations based on the actual dump information, the updated array of dump locations including, at least, updated dump location instructions, the updated dump locations based, in part, on the array of dump locations and the actual dump information.

### TECHNICAL FIELD

The present disclosure generally relates to process planning for dumping operations and, more particularly, relates to systems for dynamically altering dumping operations based on present conditions.

### BACKGROUND

In a variety of industrial operations, such as material movement operations, mining operations, hauling operations, and the like, machines may be employed to load and/or dump materials at specific areas on a worksite. In such operations, the machines, such as, but not limited to, trucks, loaders, and the like, may haul materials from one location of the worksite to a second location on the worksite. When the machines arrive at said second location, the machine may then dump materials, which had been previously loaded on to the machine, at the second location.

Such dumping operations may be performed in association with control systems for the machines, when operating on a worksite. Control systems, when employed in dumping operations, may control travel and/or dumping operations of the machine to perform the dumping tasks. For example, control systems may be used to aid in control of the machines, during a dumping operation, in accordance with any manual, autonomous, or semi-autonomous control schemes.

In some example control systems and/or methods employed in dumping operations, control systems and/or methods may be configured to define a location on the worksite in which the machine(s) are to dump materials. For example, the systems and methods disclosed by U.S. Pat. No. 8,983,707 (“Machine Control System Having Autonomous Dump Queing”), which shares a common Assignee with the instant application, may determine and/or define dump locations on a work site, said dump locations having certain boundaries.

However, in practice, the conditions at a worksite may be changing frequently and the conditions or effects of one dumping operation may affect a subsequent dumping operation. Therefore, systems and methods for planning dumping operations, wherein dump locations may be dynamically altered, are desired.

### SUMMARY

In accordance with one aspect of the disclosure, a system for planning material dumping operations for one or more machines, operating on a worksite, is disclosed. The system may include one or more machine controllers and a dump zone controller. Each of the one or more machine controllers may be associated with one of the one or more machines and configured to provide dump planning information for the one or more machines. Each of the one or more machine controllers may be further configured to determine actual dump information for dumping operations of one of the one or more machines, the dump information including, at least, first actual dump information and the dumping operations including, at least, a first dumping operation, the first actual dump information being associated with the first dumping operation. Each of the one or more machine controllers may be further configured to provide the first actual dump information to the dump zone controller. The dump zone controller may be communicatively coupled with each of the one or more machine controllers and configured to initialize a dump zone on the worksite. The dump zone controller may further be configured to plan an array of dump locations at the dump zone, the array of dump locations including, at least, a first dump location and a second dump location, and determine first dump location instructions, based on a first dump location of the array of dump locations, the first dump location instructions associated with the first dumping operation. The dump zone controller may further be configured to receive the first actual dump information from the one or more machine controllers, and update the array of dump locations based on the first actual dump information, the updated array of dump locations including, at least, updated dump location instructions, the updated dump locations based, in part, on the array of dump locations and the first actual dump information. The dump zone controller may further be configured to provide the updated array of dump locations, at least in part, to the one or more machine controllers.

In accordance with another aspect of the disclosure, an operator display, associated with a machine operating on a worksite, is disclosed. The operator display may include a visual display, a memory, a positioning device, and a controller. The memory may include a non-transitory, machine-readable medium. The positioning device may be configured to determine positioning information associated with at least one of the machine, the worksite, or any combinations thereof. The controller may be configured to execute control instructions stored on the memory. The control instructions may be for determining positioning of the machine based on the positioning information and determining actual dump information for dumping operations of the machine, the dump information including, at least, first actual dump information and the dumping operations including, at least, a first dumping operation, the first actual dump information being associated with the first dumping operation. The control instructions may be further for providing the visual display with instructions to display a visual approximation of the worksite, the visual approximation including a dump zone, the dump zone being a region of the worksite in which dumping operations are to be performed. The control instructions may be further for providing the visual display with instructions to display a first dump location, the first dump location displayed as superimposed on the visual approximation of the worksite, the first dump location being one of an array of dump locations at the dump zone, the array of dump locations including, at least, the first dump location and a second dump location. The control instructions may be further for providing the visual display with instructions to display one or more dump locations of an updated array of dump locations, the updated array of dump locations based, at least in part, on the array of dump locations and the first actual dump information, the updated array of dump locations including, at least, updated dump location instructions.

In accordance with yet another aspect of the disclosure, a method for planning material dumping operations for one or more machines operating on a worksite is disclosed. The method may include initializing a dump zone on the worksite and planning an array of dump locations at the dump zone, the array of dump locations including, at least, a first dump location and a second dump location. The method may further include receiving actual dump information for dumping operations of one of the one or more machines, the dump information including, at least, first actual dump information and the dumping operations including, at least, a first dumping operation, the first actual dump information being associated with the first dumping operation. The method may further include updating the array of dump locations based on the first actual dump information, the updated array of dump locations including, at least, updated dump location instructions, the updated dump locations based, in part, on the array of dump locations and the first actual dump information.

### BRIEF DESCRIPTION OF THE DRAWINGS

FIG. 1 is a side view of a machine and elements of an associated system for planning material dumping operations, in accordance with an embodiment of the disclosure.

FIG. 2 is a schematic diagram of the system for planning material dumping operations, which is partially shown in FIG. 1, in accordance with FIG. 1 and the present disclosure.

FIG. 3 is another schematic diagram of the system for planning material dumping operations of FIGS. 1 and 2, illustrating utilization of a plurality of machine controllers for a plurality of machines, in accordance with FIG. 1, FIG. 2, and the present disclosure.

FIG. 4 is a top-down view a worksite on which the machine and/or the system of FIGS. 1-3 may be utilized, including markings designating a dump zone and a plurality of dump locations, in accordance with an embodiment of the present disclosure.

FIG. 5 is another top down view of the worksite on which the machine and/or the system of FIGS. 1-3 may be utilized, including markings designating the dump zone, plurality of dump locations, an actual dump location for a first dumping operation, and an updated second dumping location for a second dumping operation, in accordance with an embodiment of the present disclosure.

FIG. 6 is another top down view of the worksite on which the machine and/or the system of FIGS. 1-3 may be utilized, including markings designating the dump zone, plurality of dump locations, and an updated dumping location for a dumping operation, in accordance with an embodiment of the present disclosure.

FIG. 7 is a schematic diagram for an example operator display, which may be used in conjunction with the system of FIGS. 1-6 and, additionally or alternatively, elements of the system of FIGS. 1-6 may be utilized by, or in conjunction with, the operator display, in accordance with an embodiment of the disclosure

FIG. 8 is a simplified side view of the operator display of FIG. 7, for use in conjunction with the machine and/or the system of FIGS. 1-3, the operator display displaying a top down view of the worksite and any machine(s) thereon, the top down view of the worksite including instructions superimposed upon images of the worksite and/or machine(s) thereon, in accordance with an embodiment of the disclosure.

FIG. 9 is another simplified side view of the operator display for use in conjunction with the machine and/or the system of FIGS. 1-3, the operator display displaying a magnified top down view of the worksite and any machine(s) thereon, the top down view of the worksite including instructions superimposed upon images of the worksite and/or machine(s) thereon, in accordance with an embodiment of the disclosure.

FIG. 10 is a flowchart illustrating a method for planning material dumping operations, in accordance with an embodiment of the disclosure.

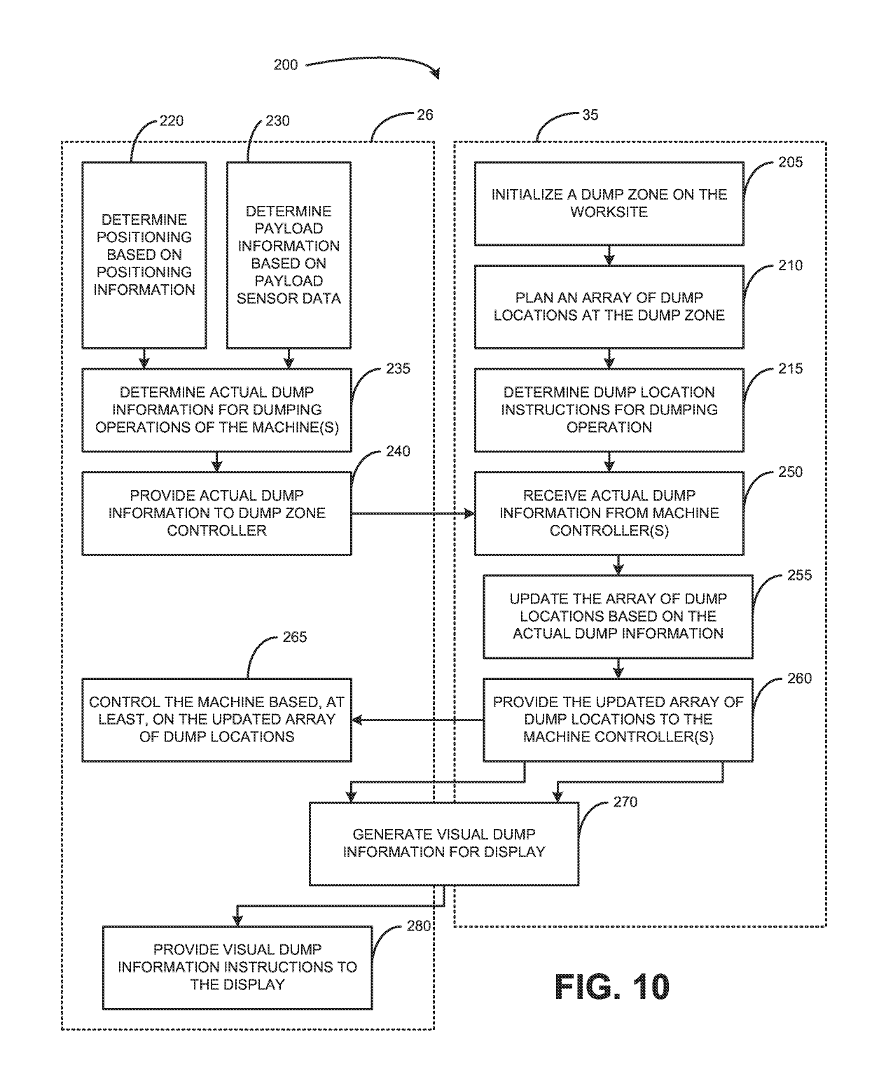

### DETAILED DESCRIPTION

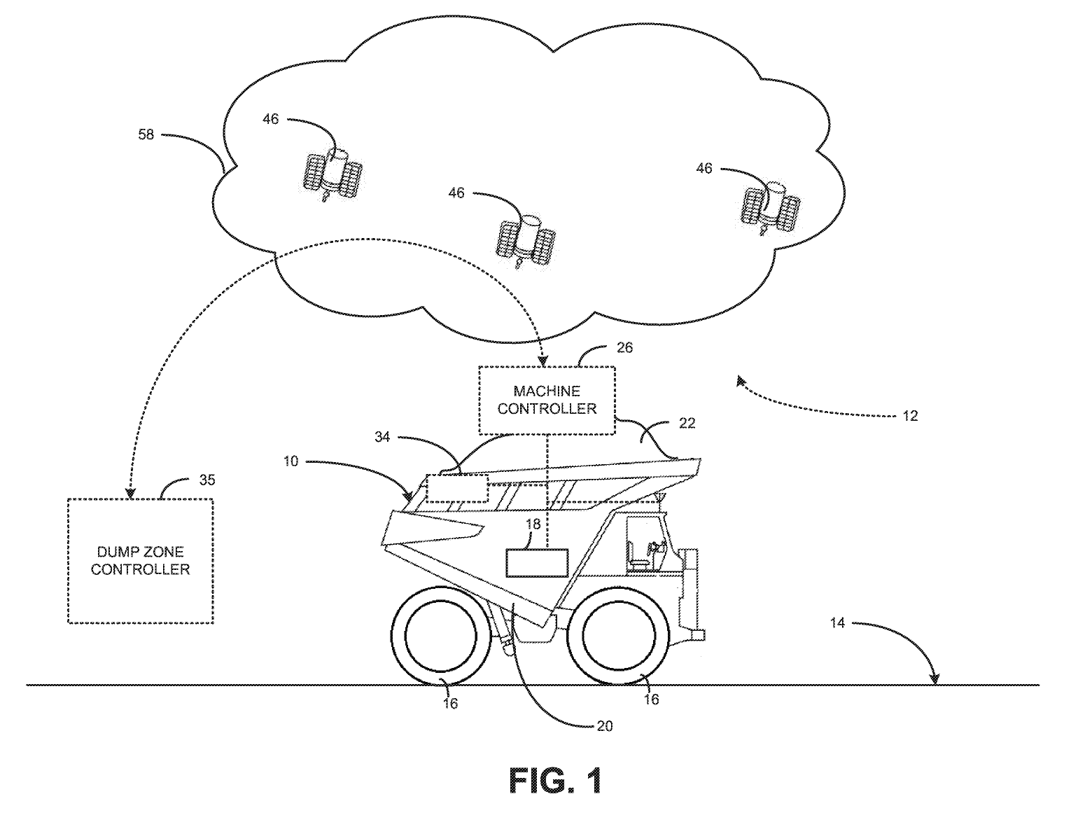

Turning now to the drawings and with specific reference to FIG. 1, a machine 10 and a system 12 for planning material dumping operations for the machine 10, and any additional machines 10 operating on a worksite 14, are shown. While the machine 10 in FIG. 1 is depicted, generally, as a truck-type machine, the teachings of the present disclosure may relate to other work machines. The term “machine” as used herein may refer to any machine that performs some type of operation associated with material movement such as, but not limited to, earth moving, construction, mining, and/or farming. For example, the machine 10 may be an earthmoving machine, such as a bulldozer, wheel loader, excavator, dump truck, mining truck, backhoe, motor grader, material handler, tele-handler, or the like.

In the illustrated embodiment, the machine 10 can be any machine used on the worksite 14 for large scale material movement and generally includes a plurality of wheels 16, a prime mover 18, and a bed 20 for carrying a payload 22. The prime mover 18 may provide power to propel the machine 10 using the wheels 16, or any other suitable traction device. Additionally, the prime mover 18 may be configured to raise and lower the bed 20. Control of propulsion, steering, and any working functions (e.g., raising and lowering the bed 20) may be performed in conjunction with the system 12.

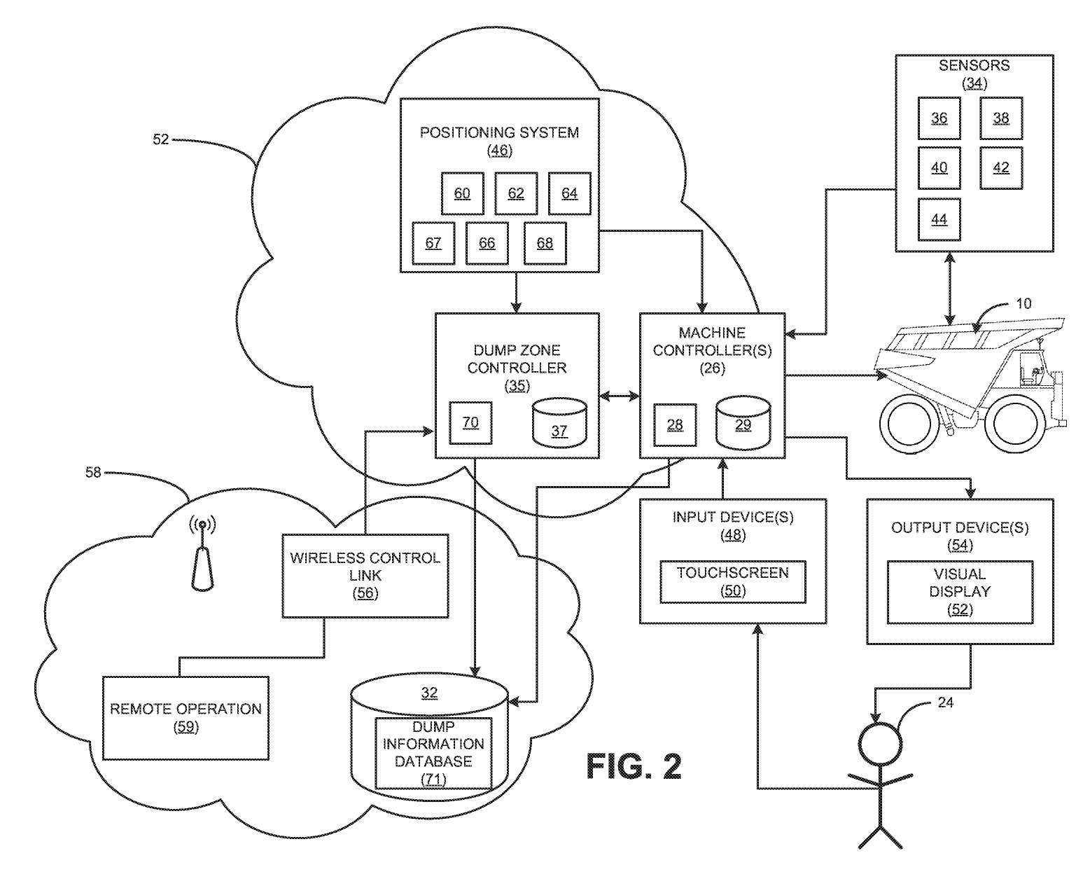

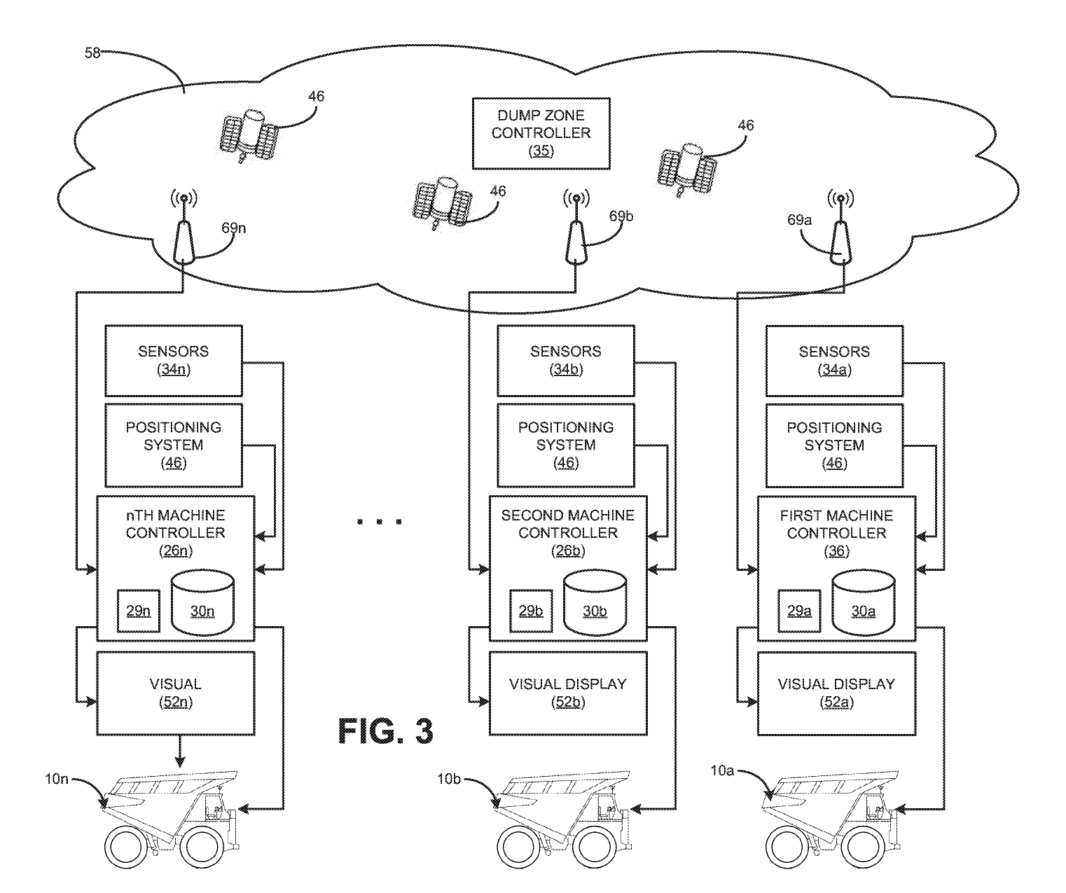

While the connections between elements of the system 12 are best shown in the schematic views of FIGS. 2 and 3, some elements are also represented in FIG. 1 and denoted, in FIG. 1, schematically, by boxes associated with the machine 10, wherein said boxes representative of elements of the system 12 and connections between such elements of the system 12 are signified by dotted lines. The system 12 may be used to control the machine 10 in a variety of autonomous, semi-autonomous, or manual modes. As used herein, the machine 10 operating in an autonomous manner operates automatically based upon information provided by the system 12, without the need for human operator input. Further, when the machine 10 operates semi-autonomously, control of the machine 10 involves an operator, either within the machine 10 or remotely, who performs some tasks or provides some input while other tasks are performed automatically based upon information provided by the system 12. If the machine 10 is operating manually, an operator is controlling all or essentially all of the direction, speed, and manipulating functions of the machine 10.

Referring now to FIG. 2 and with continued reference to FIG. 1, a schematic diagram of the system 12 is shown. While the connections between elements of the system 12 are best shown in the schematic depiction of FIG. 2, as noted above, some elements are also represented in FIG. 1 and denoted, schematically, by boxes having dotted lines.

Operation of the machine 10, in any of the above referenced manners, may be executed by a machine controller 26. The machine controller 26 may be any electronic controller or computing system including a processor 28 which performs operations, executes control algorithms, stores data, retrieves data, gathers data, actuates actuators associated with the machine 10 and/or performs any other computing or controlling task desired. The machine controller 26 may be a single controller or may include more than one controller disposed to control various functions and/or features of the machine 10. Functionality of the machine controller 26 may be implemented in hardware and/or software and may rely on one or more data maps relating to the operation of the machine 10. To that end, the machine controller 26 may include internal memory 30 and/or the machine controller 26 may be otherwise connected to external memory 32, such as a database or server. The internal memory 30 and/or external memory 32 may include, but are not limited to including, one or more of read only memory (ROM), random access memory (RAM), a portable memory, and the like. Such memory media are examples of, or include, nontransitory memory media.

For determining characteristics associated with the machine 10, including those characteristics associated with the payload 22, the machine controller 26 may be operatively associated with one or more sensors 34. The term “sensor” is used in its broadest sense to include one or more sensors and related components that may be associated with the machine 10 and that may operate to sense functions, operations, and/or operating characteristics of the machine 10. The sensors 34 may provide data, either directly or indirectly, which is indicative of various parameters and conditions associated with the machine 10. As shown, the sensors 34 include tire pressure sensors 36, suspension system pressure sensors 38, a payload monitoring system 40, engine speed sensor(s) 42, and accelerometer(s) 44. Further, the sensors 34 are not limited to including the referenced sensors and may include any other sensors useful for providing information associated with conditions of the machine 10 to the machine controller 26 or any additional controller, such as a dump zone controller 35.

The tire pressure sensors 36 and suspension system pressure sensors 38 may be used to, respectively, determine tire pressure of tires associated with the wheels 16 and determine suspension system pressures associated with a suspension of the machine 10. By utilizing the pressure calculations, the machine controller 26 may derive information associated with the payload 22, such as the weight or mass of the payload 22. For example, the machine controller 26 may examine pressure changes on sides of the truck to determine pressure caused by the payload 22, and derive weight of the payload 22 from such pressures.

Payload information may also be gathered by utilizing the payload monitoring system 40. The payload monitoring system 40 may be any collection of sensors disposed proximate to the payload 22 that gather information associated with the weight, height, position, or consistency of the payload 22. For example, the payload monitoring system 40 may include a plurality of pressure pads and/or pressure sensors disposed on or beneath the bed 20. Such a plurality of pressure pads and/or sensors may then determine the weight of the payload 22 at specific locations on the bed 20. This weight information can then be utilized by the machine controller 26 to determine payload information. In some examples, the payload monitoring system 40 and/or the sensors 34 may include one or more scales and/or loader units, configured to determine payload information and communicate said information to, for example, one of the machine controllers 26

The system 12 may also include a positioning system 46 for monitoring and/or controlling movement of the machine 10 and/or terrain conditions or images associated with the worksite 14. The positioning system 46 may include, for example a global positioning system (“GPS”), a global navigation satellite system (GNSS), an inertial guidance system, ranging radios, and/or a vision system of lasers or cameras. The positioning system 46 may sense the position of the machine 10 relative to the associated worksite 14.

The positioning system 46 may include a plurality of individual sensors that cooperate to provide signals to the machine controller 26 to indicate the position of the machine 10 and/or map characteristics of a work surface, such as topography of the worksite 14. Using the positioning system 46, the controller may determine the position of the machine 10 within the work area as well as determine the orientation of the machine 10. With said information, dimensions of the machine 10 and/or the associated worksite 14 may be stored by the system 12 with the positioning system 46 defining a datum or reference point on the machine 10 and the controller(s) 26, 35 using the dimensions to determine a position of the terrain or work surface upon which the machine 10 is operating.

Input device(s) 48 may be included with the system 12 so that the operator 24 may enter data to the machine controller(s) 26 and/or have the ability to operate the machine 10. For example, input device(s) 48 may be provided in a cab of the machine 10, wherein the operator 24 may provide commands when the machine 10 is operating in either a manual or semi-autonomous manner. The input device(s) 48 may include one or more input devices through which the operator 24 may issue commands to control the propulsion and steering of the machine 10 as well as operate various implements associated with the machine 10. In some examples, the user input may include a touchscreen 50, which may be functionally associated with a visual display 52.

The visual display 52 may be representative of or included in one or more output device(s) 54 of the system 12. To output information based on output signals provided by the machine controller 26, the output device(s) 54 may include, but are not limited to including, audio output devices, vibratory output devices, and the visual display 52. Audio output devices may be any audio device capable of providing an audible signal to an operator 24. For example, the audio output device may be a speaker. Such audible signals may be any audible noise of any amplitude, configured to provide the operator 24 with stimulus, in response to a signal from the machine controller 26. The visual display 52 may be a screen or any visual device which may be configured to provide the operator 24 with any form of visual stimuli or visual feed, in response to signals from the machine controller 26. The visual display 52 may be on board the machine 10, may be off board with respect to the machine 10 (e.g., at a remote operator station) or in any location suitable to being seen by the operator 24 or any other user. Further, vibratory output devices may be any vibratory and/or haptic devices configured to alert the operator 24 via one or more vibrations, in response to a signal from the machine controller 26.

Additionally or alternatively, the system 12 may include a wireless control link 56 which is connected to a network 58 (e.g., a wireless network). Via the wireless control link 56, commands may be given to the machine 10 via the machine controller 26 from a remote operation 59 (e.g., a command center, a foreman's station, and the like). Further, information may be accessed from and/or stored to the external memory 32. In certain embodiments, control of the machine 10 via the system 12 may be distributed such that certain functions are performed at the machine 10 and other functions are performed via remote operation 59.

As mentioned above, the positioning system 46 may be employed to determine positioning of the machine 10 and/or to determine topography or any other position-based characteristics associated with the machine 10 and/or the worksite 14. The positioning system 46 may include one or more Global Navigation Satellite System (GNSS) sensors 60 for detecting locations of the machine 10 or one or more elements of the machine 10 relative to the worksite 14. Other elements of the positioning system 46 may include, but are not limited to including, odometers 62, wheel rotation sensing sensors 64, perception based system sensors 66, ranging radios 67, and laser position detection systems 68. All elements of the positioning system 46 may be used to determine the real time actual profile of the work surface to be used for analysis by the system 12. Of course, other elements aiding in detecting positioning of the machine 10 or the worksite 14 may be included and input from the sensors 34 may also be used in determining the topography of the work surface and/or positioning of one or more machines 10 on the worksite 14.

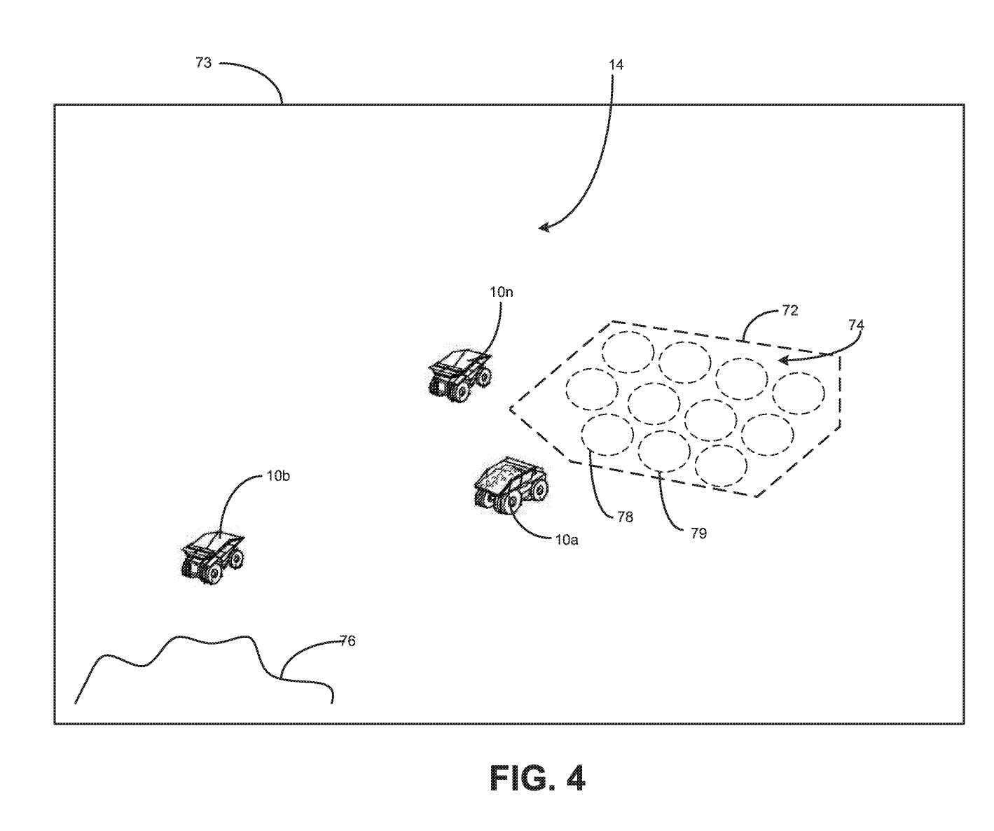

The system 12 may further include the dump zone controller 35, which is communicatively coupled with the machine controller 26 and any additional machine controller(s) 26. The dump zone controller 35 is configured to receive information from the machine controller(s) 26 and determine dump zones and arrays of dumping locations within such dump zones. A dump zone may be any segment or zone within the worksite 14, in which it is desired that the machine(s) 10 dump materials from a payload, such as the payload 22. A dumping location may be a point, or an approximation of a point to some tolerance, within a dump zone, in which it is desired that materials are dumped. Accordingly, a dump zone may encapsulate an array of dump locations, which may be ordered in a manner desired by one or both of the operator 24 and internal logic or instructions of the dump zone controller 35. Examples of dump zones and dump locations are discussed in greater detail and defined below, in reference to FIGS. 4-6.

Similar to the machine controller(s) 26, the dump zone controller 35 may be any electronic controller or computing system including a processor 70 which performs operations, executes control algorithms, stores data, retrieves data, gathers data, and/or performs any other computing or controlling task desired. The dump zone controller 35 may be a single controller or may include more than one controller disposed to for dumping operation planning. Functionality of the dump zone controller 35 may be implemented in hardware and/or software and may rely on one or more data maps relating to dumping operation planning. To that end, the dump zone controller 35 may include internal memory 37 and/or the dump zone controller 35 may be otherwise connected to the external memory 32, such as a database or server. The internal memory 37 may include, but is not limited to including, one or more of read only memory (ROM), random access memory (RAM), a portable memory, and the like. Such memory media are examples of, or include, non-transitory, machine readable, memory media.

FIG. 3 shows another schematic representation of the system 12, wherein the system 12 may be configured to utilize multiple machine controllers 26a, 26b, 26n to provide and/or determine dump planning information for multiple machines 10a, 10b, 10n. Each of the machine controllers 26a, 26b, 26n may be operatively associated with one of the machines 10a, 10b, 10n; for example, first machine 10a is operatively associated with first machine controller 26a, second machine 10b is operatively associated with second machine controller 26b, up to any number of “n” machine controllers 26n, each of which is operatively associated with one of “n” machines 10n. Each machine controller 26a, 26b, 26n may be operatively associated, respectively, with sensors 34a, 34b, 34n, which may be any sensors, as defined above with reference to the sensors 34 of FIG. 2. Further, each machine controller 26a, 26b, 26n, may be operatively associated with one or more elements of the positioning system 46, as defined above with reference to the positioning system 46 of FIG. 2. Additionally, each machine controller 26a, 26b, 26n may be operatively associated with an output device 54, such as, respectively, (as shown) the operator displays 52a, 52b, 52n.

Each machine controller 26a, 26b, 26n may be any electronic controller or computing system including a processor 28a, 28b, 28n which performs operations, executes control algorithms, stores data, retrieves data, gathers data, actuates actuators associated with respective machines 10a, 10b, 10n and/or performs any other computing or controlling task desired. Each machine controller 26a, 26b, 26n may be a single controller or may include more than one controller disposed to control various functions and/or features of the respective machines 10a, 10b, 10n. Functionality of each machine controller 26a, 26b, 26n may be implemented in hardware and/or software and may rely on one or more data maps relating to the operation of the respective machines 10a, 10b, 10n. To that end, each machine controller 26a, 26b, 26n may include respective internal memories 30a, 30b, 30n and/or each machine controller 26a, 26b, 26n may be otherwise connected to external memory 32, such as a database or server. The internal memories 30a, 30b, 30n may include, but are not limited to including, one or more of read only memory (ROM), random access memory (RAM), a portable memory, and the like.

Further, as shown, each machine controller 26a, 26b, 26n may be communicatively coupled with the dump zone controller 35. As shown in the non-limiting example, each machine controller 26a, 26b, 26n is connected to the dump zone controller 35 via the network 58; however, each machine controller 26a, 26b, 26n is certainly not limited to communicative coupling via the network 58 and any suitable system or device for communicatively coupling each machine controller 26a, 26b, 26n with the dump zone controller 35 may be employed. As shown, each machine controller 26a, 26b, 26n may be connected to the network 58 via wireless connectivity links 69a, 69b, 69n.

Turning now to FIG. 4 and with continued reference to the system 12, machine(s) 10, and elements thereof of FIGS. 1-3, a top-down view 73 of the worksite 14 is shown, wherein markings indicating both a dump zone 72 and an array of dump locations 74 are shown. The markings indicating the dump zone 72, the array of dump locations 74, and any other locational indications to be discussed hereafter, used for the purposes of discussion, are illustrated in dashed lines. Both the dump zone 72 and the array of dump locations 74 may be determined by the dump zone controller 35.

The dump zone controller 35 may be configured to initialize the dump zone 72 with respect to the worksite 14. Initializing the dump zone 72, by the dump zone controller 35, may include, but is not limited to including, designating parameters for the dump zone 72 (e.g., boundaries of the dump zone 72; boundary tolerances for the dump zone 72; lengths, widths, and heights of zone areas; etc.), designating elevation limits for material piles within the dump zone 72, designating the type of material to be dumped at the dump zone 72, designating layer thickness for each layer of the dumps at the dump zone 72, designating an average amount of materials expected per dump at the dump zone 72, designating any material type and/or properties of a material pile 76 from which the materials for one or more dumps are taken, any additional initialized conditions associated with the materials of the material pile 76 and/or worksite 14, and any combinations of any of the aforementioned conditions.

In some examples, the dump zone controller 25 may be further configured to receive the positioning information from the positioning system 46, wherein the positioning information may include, at least, current terrain information associated with the worksite 14. Current terrain information may include, but is not limited to including, topography information associated with the worksite 14, from which a virtual, approximate, and/or actual image of the worksite 14 may be derived or approximated. Accordingly, in such examples wherein current terrain information associated with the worksite 14 is provided to the dump zone controller 35, initializing the dump zone 72 may be based, at least in part, on the current terrain information

With the dump zone 72 initialized, the dump zone controller 35 may plan the array of dump locations 74. The array of dump locations 74 may include any number of dump locations in any order or configuration. For the purposes of the proceeding discussion, a first dump location 78 and a second dump location 79 are labeled and will be referenced, which are included as part of the array of dump locations 74. Planning the array of dump locations 74 may include, but is not limited to including, determining a starting location for the array of dump locations 74 (e.g., the first dump location 78), determining a progression direction for the array of dump locations 74 (e.g., proceeding in rows left to right, proceeding in rows right to left, proceeding in columns north to south, proceeding in columns south to north, or any dump progression pattern or randomization), determining an end of row action (e.g., a “type writer” style end of row action wherein the next row starts beneath the beginning of a prior row, or a “snake style” end of row action, wherein the next row of dump locations starts beneath the end of a previous row), and any combinations thereof.

With the dump zone 72 initialized and the array of dump locations 74 planned, the dump zone controller 35 may determine first dump location instructions for the machine 10, which are associated with a first dumping operation to be performed by the machine 10. The first dumping operation may be one of many dumping operations performed or to be performed by the machine 10 or any additional machine(s) 10, wherein one of the machines 10 dumps materials (e.g., the payload 22) on the worksite 14.

While the actions discussed prior and henceforth are applicable to any machine 10 and any associated machine controller 26, the present example will focus, generally, on “the machine 10” and “the machine controller 26.” However, it is to be understood that the prior and henceforth actions both performed by the machine controller 26 and the dump zone controller 35 are certainly applicable to any machine 10 and/or performable by any machine controller 26, such as, but not limited to, the machines 10a, 10b, 10n and the machine controllers 26a, 26b, 26n.

Before, during, and/or after the dump zone controller initializes the dump zone 72 and plans the array of dump locations 74, the machine controller 26 may be configured to determine actual dump information for one or more of the dumping operations of the machine 10. The dumping operations, for the purposes of example, may include a first dumping operation. Accordingly, actual dump information determined by the machine controller 26 may include first actual dump information, which is associated with the first dumping operation. “Actual dump information,” as defined herein, may include any information associated with magnitude, location, or other conditions associated with materials moved in a dumping operation (e.g., the payload 22) or the machine 10 during a dumping operation. For example, actual dump information may include actual dump location information for a prior dumping operation, which may be determined based on positioning information provided by the positioning system 46. Accordingly, the first actual dump information may include a first actual dump location associated with the first dumping operation. Additionally or alternatively, the actual dump information may include actual payload information associated with the dumping operations. In such examples, the actual payload information may be determined by input from one or more of the sensor(s) 34 (e.g., the payload monitoring system 40). After determining the actual dump information, including the first actual dump information, the machine controller 26 may provide the actual dump information, including the first dump information, to the dump zone controller 35 via, in a non-limiting example, the network 58.

The machine controller 26 may be configured to provide actual dump information, including, for example, the first dump information, to the dump zone controller 35. Accordingly, the dump zone controller 35 may be configured to receive the actual dump information, including the first dump information, from the machine controller 26 via, in a non-limiting example, the network 58. Utilizing, at least, the actual dump information, the machine controller 26 may be configured to update the array of dump locations 74 based on the actual dump information. Updating the actual dump information may include altering the positioning of a dump location of the array of dump locations 74 for any practical reason, including, but not limited to, prior dumps not satisfying initialized conditions for the dump zone, prior dumps being smaller or larger than expected, improper dump placement from a prior dump, a dump to be unloaded being larger or smaller than initially expected, or any other conditions that may affect the dump zone and the resultant dumps. Updating a dump location may include altering the positioning of the dump location in any direction. In the present example, the dump zone controller 35 may be configured to update the array of dump locations 74 based on the first actual dump information. In such examples, the updated dump locations may include, at least, updated dump array instructions. Such instructions may include, for example, instructions for altering the first dump location 78 and/or instructions for altering the second dump location 79. The dump zone controller 35 may then provide said updated array of dump locations, at least in part, to the machine controller 26, wherein the machine controller 26 may then utilize the updated array of dump locations for controlling a dumping operation of the machine 10 in any manual, semi-autonomous, or autonomous control mode.

In some examples, as shown in FIG. 2, the system 12 may further include a dump information database 71 which may be associated with the external memory 32. The dump information database 71 is operatively associated with at least one of the dump zone controller 35, the machine controller(s) 26, and any combinations thereof. In such examples, the dump information database 71 may be configured to receive actual dump information from at least one of the dump zone controller 35, the machine controller(s) 26, and any combinations thereof, and record the actual dump information to the memory. Utilizing the dump information database 71 may be useful in optimizing future dumping operations, determining dumping statistics, relaying said dumping statistics to the operator 24, optimizing future dumping operations based on information received, and any other useful, dumping optimization or recording task desired.

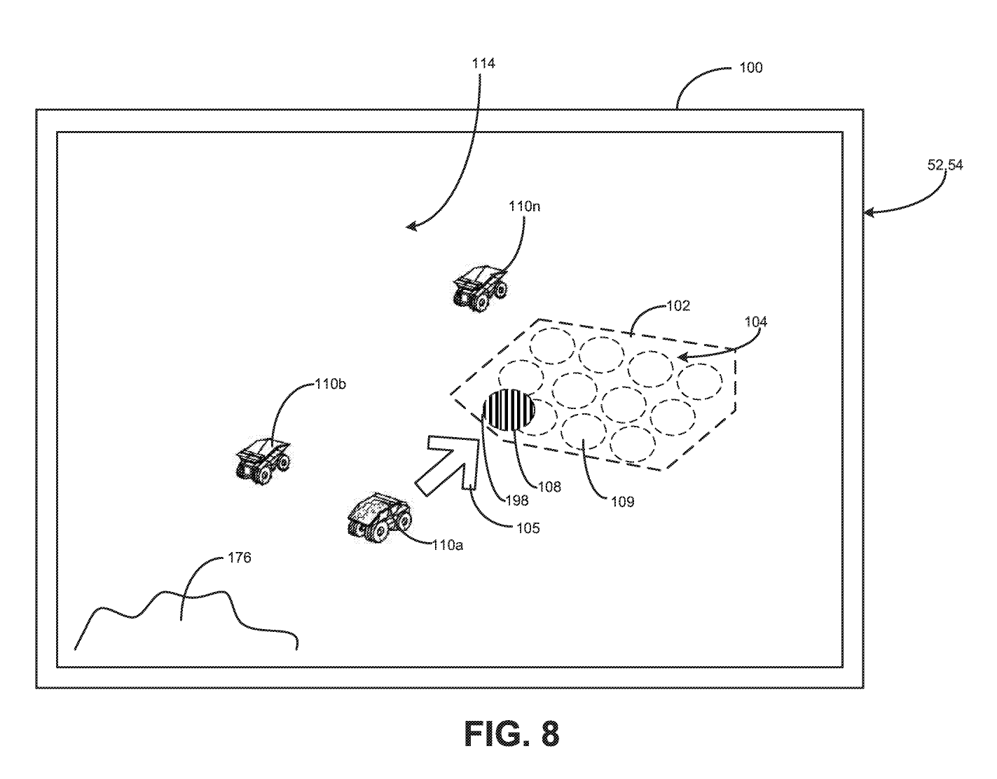

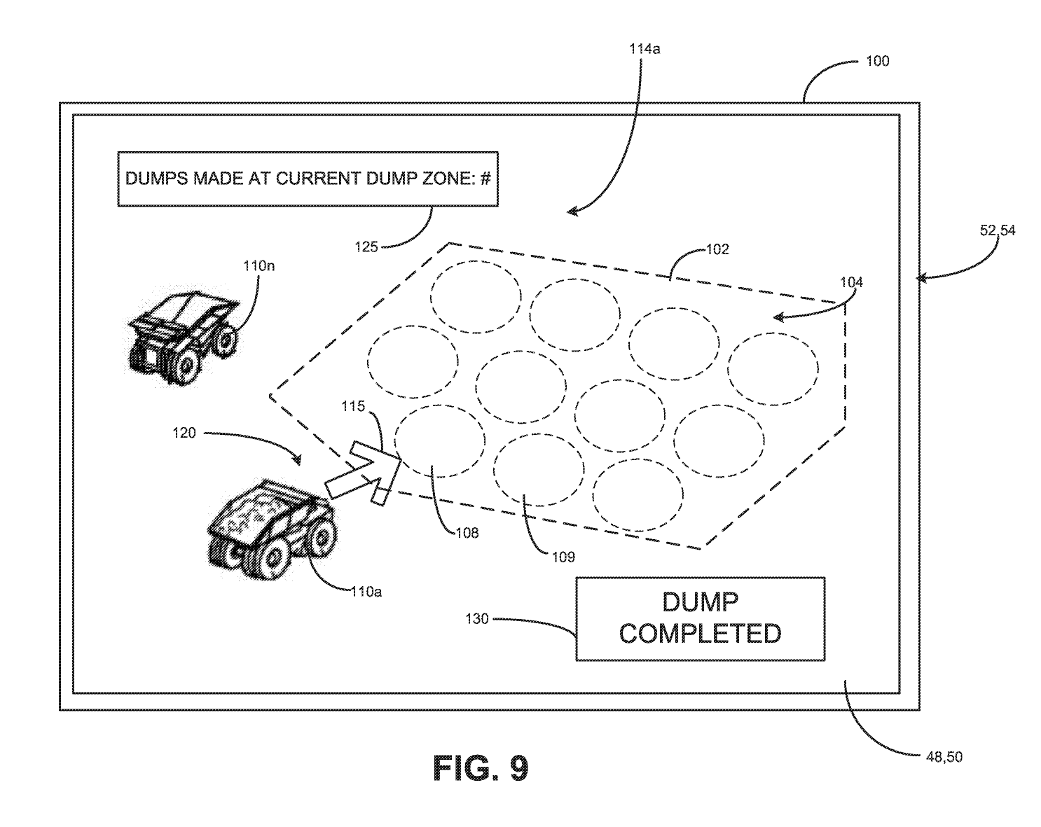

In some examples, the visual display 52 may be configured to display visual dump information to the operator 24. Visual dump information may include any information that may be associated with the worksite 14, dumping operations on the worksite 14, the actual dump information, the first dump location instructions, the updated dump locations, the machine(s) 10, dump statistics, instructions on dump guidance, the array of dump locations 74, the dump zone 72, and the like either separately or in combination, as described in more detail below with reference to FIGS. 8 and 9. In such examples, one or both of the dump zone controller 35 and the machine controller(s) 26, or combinations thereof, may be configured to generate the visual dump information. In some such examples, wherein at least one of the machine(s) 10 is operating in either a manual or semi-autonomous control mode, the visual dump guidance information may include guidance information for the user. Accordingly, the operator 24 may then control the machine(s) 10 based on such guidance information or any other visual dump information.

Alternatively, in some examples wherein at least one of the machine(s) 10 is operating in an autonomous control mode and its associated machine controller 26 is configured to autonomously control said machine 10, the machine controller 26 may be further configured to autonomously control the machine 10 based on any dump information. For example, the machine controller 26 may be configured to control the machine 10 based on, at least, the array of dump locations 74, as originally planned or as updated by the dump zone controller 35.

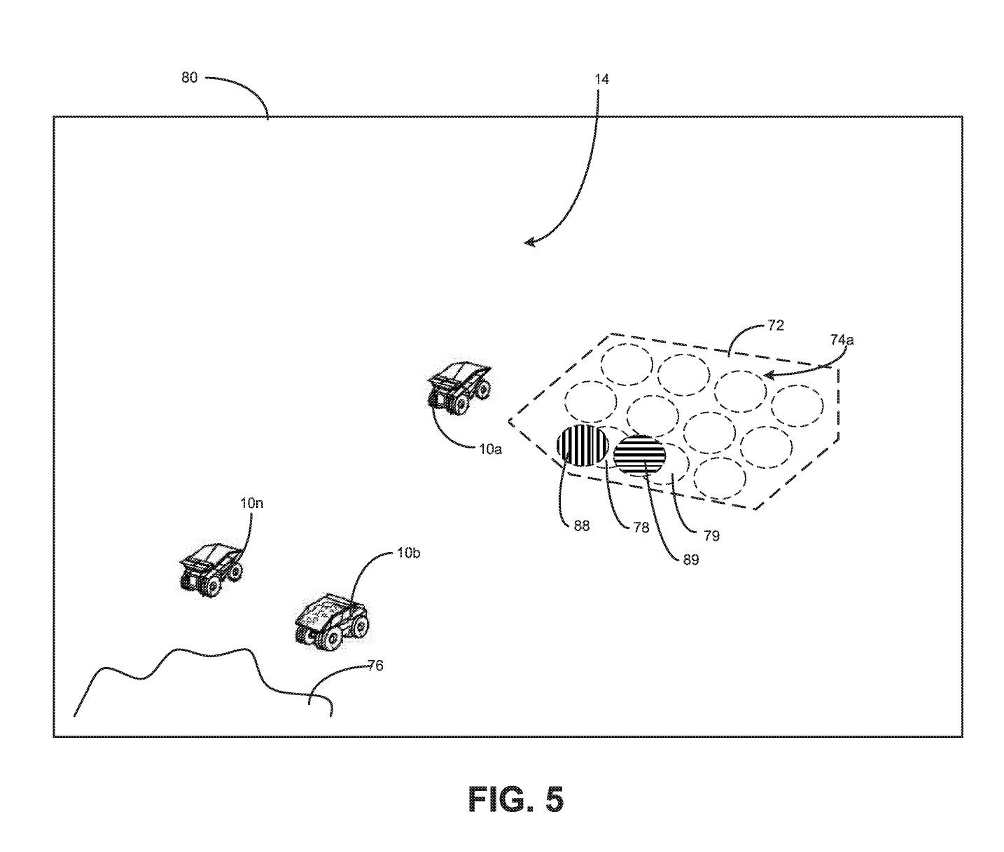

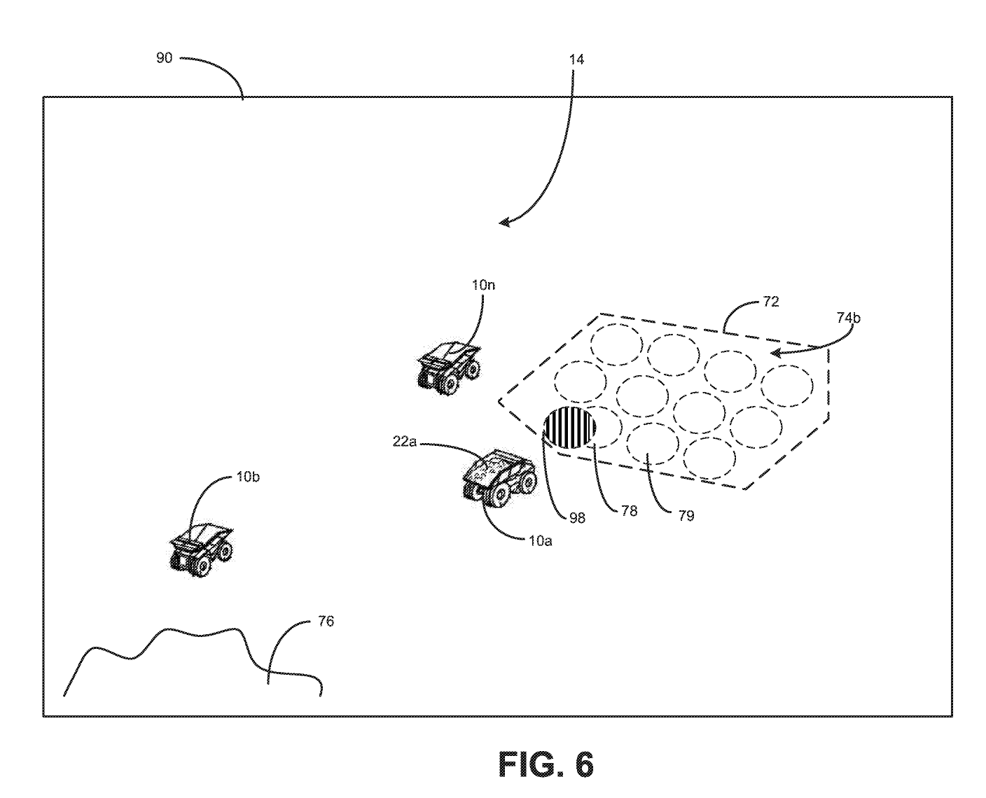

To illustrate examples in which the system 12 is utilized to dynamically plan and/or update the array of dump locations 74, the illustrations of the worksite 14, including similar and additional markings denoting the dump zone 72 and the array of dump locations 74, are provided in FIGS. 5 and 6. Beginning with FIG. 5, an example is shown in which the dump zone controller 35 utilizes the actual dump information, provided by the machine controller(s) 26, to update the second dump location 79, to an updated second dump location 89, based on an first actual dump location 88 of a first dumping operation associated with the first dump location 78. In such examples, the positioning system 46 may be utilized to provide the actual dump information, wherein said actual dump information is based, at least in part, on the positioning information. The actual dump information may include first actual dump information, which is associated with the first actual dump location 88. Based on the first actual dump information for the first actual dump location 88, the dump zone controller 35 may then update the array of dump locations 74 based on the first actual dump information to an updated array of dump locations 74a. The updated array of dump locations 74a may then include the updated second dump location 89. In view of the updated second dump location 89, the updated dump location instructions, to be provided to the machine controller(s) 26, may then include updated second dump location instructions, which may be based, at least in part, on the second dump location 79.

Updating the dump location 79 to the updated second dump location 89, by the dump zone controller 35, may include altering the positioning of the second dump location 79 for any practical reason, including, but not limited to, prior dumps not satisfying initialized conditions for the dump zone 72, prior dumps being smaller or larger than expected, improper dump placement from a prior dump, a dump to be unloaded being larger or smaller than initially expected, or any other conditions that may affect the dump zone 72 and the resultant dumps. Updating the second dump location 79 to the updated second dump location 89 may include altering the positioning of the dump location in any direction.

Turning now to FIG. 6, another example in which the system 12 is utilized to dynamically plan and/or update the array of dump locations 74 is shown. In the present example, the system 12 may be configured to update the first dump location 78, of the array of dump locations 74, to an updated first dump location 98, based on the actual dump information provided by the machine controller(s) 26. In such examples, the first actual dump information may include, at least, actual payload information, including first actual payload information associated with a first payload 22a of a machine 10a. The actual payload information, including the first actual payload information, may be based on information provided to the machine controller 26 by, for example, one or more of the sensor(s) 34, as discussed above.

In such examples, the machine 10a may be travelling to the dump zone 72 with the payload 22a. Further, in such examples, the dump zone controller 35 may be update the array of dump locations 74 based, at least, on the first payload information, to generate an updated array of dump locations 74b. In the non-limiting example of FIG. 6, the first payload information is utilized to update the first dump location 78 to an updated first dump location 98, based on the first dump location 78 and the first payload information. Updating the first dump location 78 to the updated first dump location 98, by the dump zone controller 35, may include altering the positioning of the first dump location 78 for any practical reason, including, but not limited to, payload 22a size being larger or smaller than an initialized desired payload size, prior dumps not satisfying initialized conditions for the dump zone 72, prior dumps being smaller or larger than expected, improper dump placement from a prior dump, a dump to be unloaded being larger or smaller than initially expected, or any other conditions that may affect the dump zone 72 and the resultant dumps. Updating the second dump location 79 to the updated second dump location 89 may include altering the positioning of the dump location in any direction.

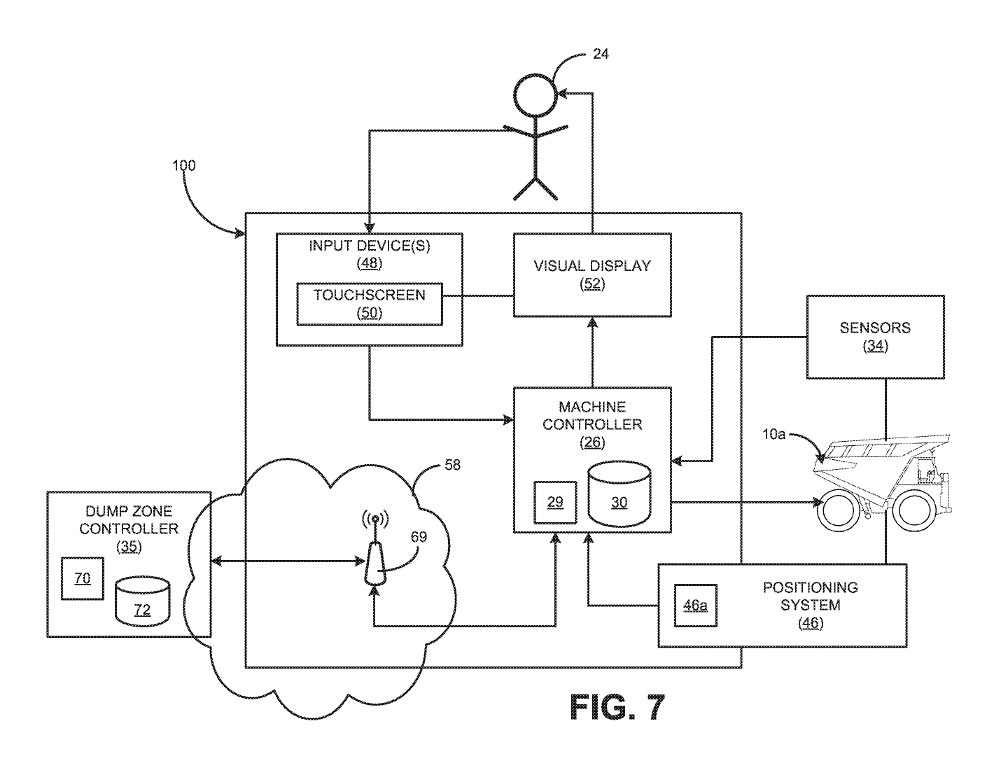

In an example embodiment of FIG. 7, an example operator display 100 is shown, in schematic form, which may be utilized in conjunction with the system 12 and any elements thereof. The operator display 100 may be any computing device operatively associated with one or more of the machine(s) 10 and configured for performance of functions of one of, or perform functions in conjunction with, the machine controller(s) 26. Accordingly, the operator display 100 may be, but is not limited to being, a mobile device, a tablet computer, a cellular phone, a laptop computer, a server, a personal computer, or any other type of computing device

As shown, the operator display 100 may include elements of the system 12 to perform functions of the operator display 100 and/or for assisting with the system 12 in performing functions of the system 12. As shown, the operator display 100 may include the visual display 52, a positioning device 46a of the positioning system 46, one of the machine controller(s) 26 and its associated memory 30 and processor 29. The memory 30, as discussed above, includes or embodies a non-transitory, machine-readable medium. The positioning device 46a may be any device, discussed above, utilized as part of the positioning system 46, which is operatively associated with the machine(s) 10. Accordingly, the positioning device 46a may be configured to determine or assist in determining the positioning information associated with at least one of the machine(s) 10, the worksite 14, or any combinations thereof.

In some examples, the operator display 100 may optionally include one of the wireless connectivity links 69, which is configured to connect the operator display 100, and any elements thereof, such as the machine controller 26, to the network 58. In such examples, the wireless connectivity link 69 may be configured to connect or communicatively couple the machine controller 26 and dump zone controller 35, via the network 58. Additionally or alternatively, the operator display 100 may optionally include one or more of the input device(s) 48, which are configured to receive input from the operator 24. In some such examples, the input device 48 may be or may include the touchscreen 50, which is functionally coupled with the visual display 52. Further, the operator display 100 may be operatively associated with the one or more sensor(s) 34, which may be utilized by the machine controller 26 in determining actual dump information.

The machine controller 26 may be configured to execute control instructions stored on the memory 30. Such instructions may include instructions for determining the actual dump information for dumping operations of the machine(s) 10, in accordance with the descriptions described above with respect to FIGS. 1-6. Accordingly, determining the actual dump instructions may include utilizing information provided by one or both of the sensor(s) 34 and the positioning system 46, as discussed above with respect to FIGS. 1-6. As discussed above, the actual dump information may include, at least, first actual dump information for a first dumping operation.

Referring now to FIG. 8 and with continued reference to FIG. 7, a simplified side view of the operator display 100 and its associated visual display 52 is illustrated showing a visual approximation of the worksite 114. The machine controller 26 may be configured to provide the visual display 52 with instructions to display the visual approximation of the worksite 114. A “visual approximation,” as defined herein, may refer to any virtual recreation or graphical representation, of any varying degree of accuracy and/or realism, of a space, zone, object, or marking representative of dumping instructions or information. The visual approximation of the worksite 114 may be any visual representation of the worksite 14 including any objects thereon, such as, but not limited to, visual indications of machine(s) 110 operating on the worksite 14, relative to the worksite 14, a visual approximation materials 176, a visual approximation of a dump zone 102, a visual approximation of an array of dump locations 104, visual approximations of first and second dump locations 108, 109, any additional visual approximations of any objects on the worksite 14, and/or any additional visual approximations of markers related to the worksite 14. As shown and mentioned above, the visual approximation of the worksite 114 may include, at least, the visual approximation of the dump zone 102, indicating a region on the worksite 14 in which dumping operations are to be performed by one or more machine(s) 10.

The machine controller 26 may further be configured to provide the visual display 52 with instructions to display the visual approximation of the first dump location 108, wherein the visual approximation of the first dump location 108 is displayed as superimposed on or as part of the visual approximation of the worksite 114. As described above, the visual approximation of the first dump location 108, as based on, for example, the first dump location 78 discussed above, may be one of an array of dump locations 74 at the dump zone 72, the array of dump locations 74 including at least the first dump location 78 and the second dump location 79. In the present example, the array of dump locations 74, the first dump location 78, and the second dump location 79 may be the basis of, respectively, the visual approximation of the array of dump locations 104, the visual approximation of the first dump location 108, and the visual approximation of the second dump location 109.

Furthermore, the machine controller 26 may further be configured to provide the visual display 52 with instructions to display one or more dump locations of the updated array of dump locations 74a, 74b, wherein the updated array of dump locations 74a, 74b are based, at least in part, on the array of dump locations 74 and the first actual dump information and include, at least, updated dump location instructions. For example, the updated array of dump locations 74b are represented in FIG. 8 as the visual approximation of the array of dump locations 104, which includes, at least, a visual approximation for an updated first dump location 198, which is based on the updated first dump location 98, discussed above with respect to FIG. 6. However, the visual approximation for array of dump locations 104 may include any markings or signifiers for any updated dump locations, in conjunction with the descriptions of the system 12, above.

As discussed above, the machine controller 26 may be communicatively associated with the dump zone controller 35. In such examples, the dump zone controller 35 may be configured to initialize the dump zone 72 on the worksite 14 and plan the array of dump locations 74 at the dump zone 72, in accordance with the detailed description of the system 12, above. The dump zone controller 35 may further be configured to receive the first actual dump information from the machine controller 26 of the operator display 100, generate the updated array of dump locations 74b, based on the first actual dump information, and transmit the updated array of dump locations 74b to the machine controller 26, in accordance with the detailed description of the system 12, above. Accordingly, in such examples, the machine controller 26 may utilize the updated array of dump locations 74b, provided by the dump zone controller 35, in providing the visual display 52 with instructions to display one or more dump locations based on the updated array of dump locations 74b.

The visual approximation of the worksite 114 may, in some examples, show changing locations of the machine(s) 110, as the visual approximations of the machine(s) 110. Such visual approximations of the machine(s) 110 may be indicative of locations of the machine(s) 10, relative to the worksite 14. Accordingly, as the visual approximation of the worksite 114 may be continually changing based on positioning of the machine(s) 10, the visual approximation of the worksite 114 may selectively include, based on machine 10 location, the visual approximation of a dump zone 102, the visual approximation of an array of dump locations 104, the visual approximations of first and second dump locations 108, 109, any additional visual approximations of any objects on the worksite 14, and/or any additional visual approximations of markers related to the worksite 14. For example, the visual approximation of the worksite 114 may include one or more of one or more of the visual approximation of an array of dump locations 104, as originally planned or as updated, when a location of the machine 10, on the worksite 14, approaches the dump zone 72 or is within the dump zone 72.

In some examples, such as the simplified side view of the operator display 100 and its associated visual display 52 illustrated in FIG. 9, the visual approximation of the worksite 114 may become a magnified visual approximation of the worksite 114a, magnified relative to the virtual approximation of the machine 110a and a zone 120 of the virtual approximation of the worksite 114 proximate to the virtual approximation of the machine 110a. In such examples, the visual approximation of the worksite 114 may become the magnified visual approximation of the worksite 114a, when the visual approximation of the machine 110a, based on a location of the machine 10a, approaches the dump zone 102 or is within the dump zone 102. In some such examples, the magnified visual approximation of the worksite 114a may include user guidance instructions 115 for one or more of the dumping operations. Said user guidance instructions 115 may be any visual cues directing the operator 24, or any control scheme controlling the machine 10, towards a dumping location at the dump zone 72. Additionally or alternatively, in examples wherein the when the visual approximation of the machine 110a, based on a location of the machine 10a, approaches the dump zone 102 or is within the dump zone 102, the machine controller 26 may be further configured to provide instructions to the visual display 52 to display dump data 125, which may include, for example, a number of past dumps of the dumping operations, as shown. Further, in some examples in which prior dumps have been made at the dump zone 102, the machine controller 26 may be further configured to provide instructions to the visual display 52 to display a number of prior dump locations that had been performed at the dump zone 102 (e.g., displaying the first and second dump locations 108, 109 once dumping operations have been completed at said locations.

As discussed above, the operator display 100 may include a touchscreen 50 as an input device 48. The touchscreen 50 may be functionally coupled with the visual display 52, such that physical touch by the operator 24, or an object in control of the operator 24 (e.g., a stylus, etc.), on a region of the visual display 52 coupled with a region of the touchscreen 50, will provide some form of user input or data. For example, as shown in FIG. 9, the controller may be configured to provide the visual display 52 with instructions to display a virtual button 130. The touchscreen 50 may be configured to provide data input when a region of the touchscreen 50 associated with the displayed virtual button 130 on the visual display 52 is physically touched by the operator 24 or an object in control of the operator 24. As shown, the virtual button 130 may act as an input device configured to receive input from the user indicating that one of the dumping operations has been completed, when touched by the operator 24 or an object in control of the operator 24. In such examples, the touchscreen 50 is configured to provide an indication that one of the dumping operations has been completed, upon physical contact with the virtual button 130 by the operator 24 or an object controlled by the operator 24 at a region of the touchscreen 50 that is functionally coupled with the region of the visual display 52 that is displaying the virtual button 130.

### INDUSTRIAL APPLICABILITY

The present disclosure generally relates to process planning for dumping operations and, more particularly, relates to systems for dynamically altering dumping operations based on present conditions. While the machines depicted in the Figures and described above are, generally, shown as truck-type machines, the teachings of the present disclosure may relate to other work machines. The systems and methods disclosed herein may apply to any machine that performs some type of operation associated with material movement such as, but not limited to, earth moving, construction, mining, and/or farming. For example, the systems and methods disclosed herein may be applicable to any earthmoving machine, such as a bulldozer, wheel loader, excavator, dump truck, mining truck, backhoe, motor grader, material handler, tele-handler, or the like.

Accordingly, the systems, methods, and apparatus disclosed herein may be utilized to optimizing dumping operations for such machines by utilizing dynamic, continuously updatable, dumping location planning at a worksite. The results of actual dumping operations may not align perfectly with a predetermined dumping plan, as the size of dumping loads, material quality, machine capability, among other factors, may not always be consistent. Therefore, the systems and methods of the present application aim to improve, dumping operations by dynamically planning dump locations of a dump array, to provide consistent quality, control, accuracy, loss prevention, and efficiency amongst one or more machines operating on a worksite.

To achieve one or more of these advantages, the system 12 and/or the operator display 100 may be utilized in addition to or in conjunction with a method 200 for planning material dumping operations for the one or more machines 10, as the machine(s) 10 operate on the worksite 14, which is depicted as a flowchart in FIG. 7. As shown the method 200 and any steps thereof may be performed by one or both of the dump zone controller 35 and the one or more machine controllers 26. The method steps are grouped to indicate which steps are, generally, performed by the dump zone controller 35, which steps are performed by the one or more machine controllers 26, and which steps may be performed by one or more of the machine controllers 26 and the dump zone controller 35; however, it is certainly contemplated that any of the dump zone controller 35, the machine controller(s) 26, any additional controllers or computing devices, and any combinations thereof may be utilized to perform any of the method steps of the method 200.

As, generally, performed by the dump zone controller 35, the method 200 may include initializing the dump zone 72 on the worksite 14, as described in more detail with reference to the system 12 and represented by block 205. The dump zone controller 35 may further plan the array of dump locations 74, as described above with reference to the system 12 and depicted in block 210. Accordingly, at block 215, the dump zone controller 35 may then determine dump location instructions for dumping operations, which may include, for example, the first dump location instructions associated with the first dumping operation, as discussed above.

Before, during, and/or after the dump zone controller 35 performs any of the steps at blocks 205, 210, and/or 215, the machine controller 26 may determine positioning of the machine 10 based on positioning information from the positioning system 46, as shown in block 220. Similarly, before, during, and/or after the dump zone controller 35 performs any of the steps at blocks 205, 210, and/or 215, the machine controller 26 may determine payload information for a payload in a dumping operation, which, in some examples, may be based on data from the sensor(s) 34. The machine controller 26 may determine actual dump information for dumping operations of the machine 10, which may include first actual dump information associated with the first dumping operation, as depicted in block 235 and provide the actual dump information to the dump zone controller 35, as depicted in block 240. As discussed in detail above, the actual dump information may be based, at least in part, on one or both of the payload information and the positioning information.

Once the machine controller(s) 26 provides the actual dump information, the dump zone controller 35 may receive said actual dump information, as depicted in block 255. Using the actual dump information, the dump zone controller 35 may then update the array of dump locations 74, in accordance with any of the descriptions of updating the array of dump locations 74 discussed above with reference to the system 12, as depicted in block 255. The dump controller may then provide the updated array of dump locations 74 to the machine controller(s) 26.

In some examples, the machine controller 26 may use the updated array of dump locations for controlling the machine 10, as depicted in block 265. Such information may be utilized by the machine controller 26 in any manual or semi-autonomous control modes, by providing instructions for controlling the machine 10 to one or both of the operator 24 and machine components of the machine 10. Alternatively, the machine controller 26 may utilize such information to autonomously control the machine 10, based on the updated array of dump locations 74.

Further, at least one of the dump zone controller 35 and the machine controller(s) 26 may be utilized to generate visual dump information for the visual display 52, as discussed above with reference to both the system 12 and the operator display 100 and as depicted by block 270. While depicted at this stage in the method 200, generating visual dump information may be performed before, during, and/or after the dump zone controller 35 and/or the machine controller(s) 26 perform any of the preceding steps. Accordingly, the machine controller(s) 26 may utilize said visual dump information to provide visual dump information instructions to the visual display 52, as depicted in block 280.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A system for planning material dumping operations for one or more machines operating on a worksite, the system comprising:
one or more machine controllers, each of the one or more machine controllers associated with one of the one or more machines and configured to provide dump planning information for the one or more machines;
a dump zone controller, the dump zone controller communicatively coupled with each of the one or more machine controllers;
each of the one or more machine controllers configured to:
determine actual dump information for dumping operations of one of the one or more machines, the dump information including, at least, first actual dump information and the dumping operations including, at least, a first dumping operation, the first actual dump information being associated with the first dumping operation, and
provide the first actual dump information to the dump zone controller, the dump zone controller configured to:
initialize a dump zone on the worksite,
plan an array of dump locations at the dump zone, the array of dump locations including, at least, a first dump location and a second dump location,
determine first dump location instructions, based on the first dump location of the array of dump locations, the first dump location instructions associated with the first dumping operation,
receive the first actual dump information from the one or more machine controllers,
update the array of dump locations based on the first actual dump information, the updated array of dump locations including, at least, updated dump location instructions, the updated dump locations based, in part, on the array of dump locations and the first actual dump information, and
provide the updated array of dump locations, at least in part, to the one or more machine controllers.

2. The system of claim 1, further comprising a positioning system communicatively coupled with at least one of the one or more machine controllers, the dump zone controller, or any combinations thereof, the positioning system configured to determine positioning information associated with at least one of the one or more machines, the worksite, or any combinations thereof,
wherein at least one of the one or more machine controllers is further configured to:
receive the positioning information from the positioning system, and
determine positioning of the machine based on the positioning information,
wherein the actual dump information includes, at least, actual dump location information, the actual dump location information based, at least in part, on the positioning information, and the first actual dump information including a first actual dump location,
wherein updating the array of dump locations, by the dump zone controller, is further based on the first actual dump location, and
wherein the updated dump location instructions include updated second dump location instructions based, in part, on the second dump location of the array of dump locations and the first actual dump location.

3. The system of claim 1, wherein the actual dump information includes, at least, actual payload information and the first actual dump information includes first payload information associated with the first dumping operation,
wherein updating the array of dump locations, by the dump zone controller, is further based on the first payload information, and
wherein the updated dump location instructions include updated first dump location instructions based, in part on the first dump location of the array of dump locations and the first payload information.

4. The system of claim 3, further comprising one or more payload sensors, each of the one or more payload sensors operatively associated with one of the one or more machines, each of the one or more payload sensors configured to determine payload information associated with the dumping operations, the payload information including the first payload information.

5. The system of claim 1, wherein initializing the dump zone, by the dump zone controller, includes at least one of designating parameters for the dump zone, designating an elevation limit for the dump zone, designating a type of material to be dumped at the dump zone, designating layer thickness conditions for the dump zone, or any combinations thereof.

6. The system of claim 1, further comprising a positioning system communicatively coupled with at least one of the one or more machine controllers, the dump zone controller, or any combinations thereof, the positioning system configured to determine positioning information associated with at least one of the one or more machines, the worksite, or any combinations thereof,
wherein the positioning information includes, at least, current terrain information associated with the worksite,
wherein the dump zone controller is further configured to receive the current terrain information associated with the worksite, and
wherein initializing the dump zone, by the dump zone controller, is based, at least in part, on the current terrain information associated with the worksite.

7. The system of claim 1, wherein planning the array of dump locations, by the dump zone controller, includes determining at least one of a starting location for the array of dump locations, a progression direction for the array of dump locations, and an end of row action for the array of dump locations.

8. The system of claim 1, further comprising one or more visual displays, each of the one or more visual displays operatively associated with one of the one or more machine controllers, the one or more visual displays configured to display visual dump information to a user,
wherein the one or more of the dump zone controller and the one or more machine controllers are configured to generate the visual dump information, the visual dump information generated based on one or more of the dumping operations, the actual dump information, the dump zone, the array of dump locations, the first dump location instructions, updated dump location instructions, and any combinations thereof.

9. The system of claim 8, wherein the visual dump information includes guidance information for the user, when at least one of the one or more machines is operating in a manual or semi-autonomous control mode.

10. The system of claim 1, further comprising a dump information database, including a memory, operatively associated with at least one of the dump zone controller, the one or more machine controllers, and any combinations thereof, the dump information database configured to:
receive the actual dump information from at least one of the dump zone controller, the one or more machine controllers, and any combinations thereof, and
record the actual dump information to the memory.

11. The system of claim 1, wherein one of the one or more machines is an autonomously controlled machine and one of the machine controllers is an automated machine controller operatively associated with the autonomously controlled machine, and
wherein the automated machine controller is further configured to autonomously control the autonomously controlled machine based on, at least, the updated array of dump locations.

12. An operator display associated with a machine operating on a worksite, the operator display comprising:
a visual display;
a memory, the memory including a non-transitory, machine-readable medium;
a controller configured to execute control instructions stored on the memory, the control instructions including instructions for:
determining actual dump information for dumping operations of the machine, the dump information including, at least, first actual dump information and the dumping operations including, at least, a first dumping operation, the first actual dump information being associated with the first dumping operation,
providing the visual display with instructions to display a visual approximation of the worksite, the visual approximation including a dump zone, the dump zone being a region of the worksite in which dumping operations are to be performed,
providing the visual display with instructions to display a first dump location, the first dump location displayed as superimposed on the visual approximation of the worksite, the first dump location being one of an array of dump locations at the dump zone, the array of dump locations including, at least, the first dump location and a second dump location, and
providing the visual display with instructions to display one or more dump locations of an updated array of dump locations, the updated array of dump locations based, at least in part, on the array of dump locations and the first actual dump information, the updated array of dump locations including, at least, updated dump location instructions.

13. The operator display of claim 12, further comprising a wireless connectivity link configured to connect the operator display to a wireless network, the wireless connectivity link connecting the controller to a dump zone controller,
wherein the dump zone controller is configured to:
initialize the dump zone on the worksite,
plan the array of dump locations at the dump zone,
receive the first actual dump information from the controller via the network,
generate the updated array of dump locations based on the first actual dump information, and
transmit the updated array of dump locations to the controller.

14. The operator display of claim 12, wherein the visual approximation of the worksite includes is an overhead approximation of the worksite which includes at least one of an indication of a location of the machine relative to the worksite, one or more indications corresponding to one or more additional machines relative to the worksite, the dump zone, and any combinations thereof.

15. The operator display of claim 14, wherein the visual approximation becomes a magnified visual approximation, magnified relative to the machine and a zone proximate to the machine, when a location of the machine, on the worksite, approaches the dump zone, and the magnified visual approximation includes user guidance instructions for one or more of the dumping operations.

16. The operator display of claim 14, wherein the visual approximation includes a visual representation of at least one of one or more of the array of dump locations, one or more of the array of updated dump locations, and any combinations thereof, when a location of the machine, on the worksite, approaches the dump zone or when the location of the machine is within the dump zone.

17. The operator display of claim 14, wherein controller is further configured to provide instructions to the visual display to display a number of past dump locations of the dumping operations, when a location of the machine, on the worksite, approaches the dump zone or when the location of the machine is within the dump zone.

18. The operator display of claim 12, further comprising an input device, the input device configured to receive input from an operator indicating that one of the dumping operations has been completed.

19. The operator display of claim 18, wherein the input device is a touchscreen functionally coupled with the visual display,
wherein the controller is further configured to provide the visual display with instructions to display a virtual button, and
wherein the touchscreen is configured to provide an indication that one of the dumping operations has been completed upon physical contact with a button region of the touchscreen, the button region functionally coupled with the virtual button.

20. A method for planning material dumping operations for one or more machines operating on a worksite, the method comprising:
initializing a dump zone on the worksite;
planning an array of dump locations at the dump zone, the array of dump locations including, at least, a first dump location and a second dump location;
receiving actual dump information for dumping operations of one of the one or more machines, the dump information including, at least, first actual dump information and the dumping operations including, at least, a first dumping operation, the first actual dump information being associated with the first dumping operation; and
updating the array of dump locations based on the first actual dump information, the updated array of dump locations including, at least, updated dump location instructions, the updated dump locations based, in part, on the array of dump locations and the first actual dump information.
